(19) United States
(12) Patent Application Publication
(10) Pub. No.: US 2008/0270202 A1
(43) Pub. Date: Oct. 30, 2008

(54) METHODS OF LIFE CYCLE OPTIMIZATION FOR SOLUTIONS INCLUDING TOOLING

(75) Inventors: Lutz Krempel, Germering (DE); Martin Schmidt, Schondorf (DE)

Correspondence Address: BELL, BOYD & LLOYD, LLP, P.O. BOX 1135, CHICAGO, IL, 60690, US

(73) Assignee: Nokia Siemens Networks GmbH & Co, Munchen (DE)

(21) Appl. No.: 11/835,176

(22) Filed: Aug. 7, 2007

Related U.S. Application Data
(60) Provisional application No. 60/914,587, filed on Apr. 27, 2007.

(51) Int. Cl. G06F 17/30

(52) U.S. Cl. 705/7

(57) ABSTRACT

This invention relates generally to a method and system for calculating product lifecycle costs, and more particularly, to automatically predicting the timing and costs of future service, maintenance and replacement events of products or a system in an optimized manner. The system and method obtain information about products in the network, store the information on a database, and calculate predicted costs for maintaining an upgrading the system over a determined lifecycle.

### BACKGROUND

This disclosure relates generally to a method and system for calculating product lifecycle costs, and more particularly, to automatically predicting the timing and costs of future service, maintenance and replacement events of products or a system in an optimized manner.

The market for long-term contractual agreements has grown at high rates over recent years for many of today's service and IT organizations. As the service organizations establish long-term contractual agreements with their customers, it becomes important to understand the expected costs and risks associated with the pricing of service contracts and portfolio management of the contracts. In addition, the service organizations need to have an understanding of the planning of repairs (shop workload planning) and how the introduction of new technology will affect their service contracts. In order to analyze these issues, it is necessary to correctly model the underlying behavior of the product or system so that each can be serviced in the most cost-effective manner.

Currently available analytical practices are unable to accurately model service and innovation requirements for complex products or systems. Typically, these models contain poor cost information which result in the service organization inefficiently managing the risk associated with their service portfolios, failing to respond to customer needs and new technology, which all lead to lower long-term contract profitability and high risk. A standard time-series method is one particular approach that has been used to model the service requirements of repairable systems such as aircraft engines, automobiles, locomotives and other high tech products. This time-series method examines historical data obtained over a five to ten year period and forms a trend line on either system costs and/or number of repairs made to the system. The trend line is then used to predict future costs and number of repairs. A limitation with this time series method is that it does not give details of failures at a compartmental level. A compartment is a physical or performance related sub-system of the repairable product, which when it fails causes the product to require maintenance or servicing. Other limitations with the standard time series method is that it does not account for the life cycle of the repairable product and thus does not provide a distribution of the expected service events for the product. An analysis based on engineering relationships to determine compartment parameters is another method used to model the service requirements of repairable systems. A limitation with this analysis is that it is not well based in underlying statistics, and thus cannot be shown to accurately model the repairable product on an ongoing basis.

Accordingly, there is a need for an approach that can model the service requirements of repairable systems that is accurate and has a comprehensive statistical framework. Such an approach will lead to better cost projections, more realistic and effective risk management, new technology introduction and day-to-day service that is more responsive to customer needs and higher long-term operational profitability.

FIG. 1 shows a schematic of a general-purpose computer system 10 in which a system for automatically predicting the timing and costs of future service events of a product operates, as disclosed in U.S. Pat. No. 6,832,205. The computer system 10 generally comprises a processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices comprise a keyboard 18 and a mouse 20 that are used to enter data and instructions into the computer system 10. A display 22 allows a user to see what the computer has accomplished. Other output devices could include a printer, plotter, synthesizer and speakers. A modem or network card 24 enables the computer system 10 to access other computers and resources on a network. A mass storage device 26 allows the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, personal computer, workstation, mini-computer, mainframe computer and supercomputer.

This system too has its limitations, as it is only able to predict costs and lifetime on a product-by-product basis. That is, the system predicts costs and lifetime of a single product. As telecommunications and IT providers have to manage and maintain networks that are becoming increasingly complex, a single product prediction does not afford the providers all of the necessary methods and tools. Network elements have different life cycles, despite being interlinked to a large extent. Changes or upgrades, of a single element may greatly impact other network elements, and therefore impact the system as a whole. Using existing methods and tools, experts can only recommend upgrades paths based on individual products which only provides a short or mid-term solution. An optimized and coordinated hardware and software method and tool is therefore required that can automatically predict the timing and costs of future service, maintenance and replacement events of products to an entire solution.

### SUMMARY

A method and system is disclosed for calculating product lifecycle costs, and more particularly, to automatically predicting the timing and costs of future service, maintenance and replacement events of products or a system in an optimized manner. The system and method obtain information about products in the network, store the information on a database, and calculate predicted costs for maintaining an upgrading the system over a determined lifecycle.

In one exemplary embodiment, there is a system for predicting lifecycle costs of products in a solution, including a database storing information related to the products in the system; and a calculation tool to determine an accumulated cost for the lifecycle of the solution.

In another exemplary embodiment, the calculation tool obtains information stored in the database; ranks combinations for each of the products based on the obtained information; determines upgrade paths for each of the products based on the obtained information and ranked combinations; and ranks the upgrade paths based on the determined upgrade paths and overall cost associated with each upgrade path.

In another exemplary embodiment, the database includes an installed equipment section storing information identifying the amount of each of the products installed in the system; an OPEX information section storing operational costs for each of the products, including at least one of infrastructure costs, maintenance costs and administrative costs; a roadmap table section storing at least one of availability and version information for each of the products; a CAPEX information section storing capital expenditures for each of the products, including at least one of a price for each of the products, a price to upgrade each of the products and a price to replace each of the products; and a compatibility matrix section storing information regarding the compatibility of each of the products, the information identifying each of the products as one of independent, incompatible, compatible and customized.

In still exemplary embodiment, the information obtained by the calculation tool includes information stored in the installed equipment section, OPEX information section, roadmap table section, CAPEX information section and compatibility matrix section.

The system may include an output device to display the predicted lifecycle costs of the products in the solution based on calculations made by the calculation tool. Also, the output device displays at least one of a history, output table and graphical output.

Under the exemplary embodiments, the database may collect and store information from a plurality of sources, and the collected and stored information may be used to generate tables and relational data about each of the products The calculation tool may determine the accumulated cost by calculating at least one of ranking combinations for each of the products based on the tables and relational data, determine upgrade paths for each of the products based on the ranked combinations, and rank the upgrade paths based on the determined upgrade paths and overall cost associated with each upgrade.

In another exemplary embodiment, there is a method for predicting lifecycle costs of products in a solution, including storing information related to the products in the system in a database; and determining an accumulated cost for the lifecycle of the solution using a calculation tool.

In still another exemplary embodiment, there is a computer-readable medium storing a computer program for instructing a computer to predict lifecycle costs of products in a solution, including storing information related to the products in the system in a database; and determining an accumulated cost for the lifecycle of the solution using a calculation tool.

Additional features and advantages are described herein, and will be apparent from, the following Detailed Description and the figures.

### BRIEF DESCRIPTION OF THE FIGURES

FIG. 1 shows a schematic of a general-purpose computer system in which a system for automatically predicting the timing and costs of future service events of a product operates as known in the prior art.

FIG. 2 shows an exemplary diagram of the extended technical solution lifecycle of a network.

FIG. 3 shows an exemplary diagram illustrating options for a single product upgrade.

FIG. 4 shows an exemplary diagram illustrating individual the lifecycle of products and upgrade variants in a solution.

FIG. 5 shows a schematic diagram for calculating lifecycle costs in accordance with an exemplary embodiment.

FIG. 6 shows an exemplary flow diagram of the method in accordance with an exemplary embodiment.

FIG. 7 shows an exemplary flow diagram of a calculation algorithm in accordance with an exemplary embodiment.

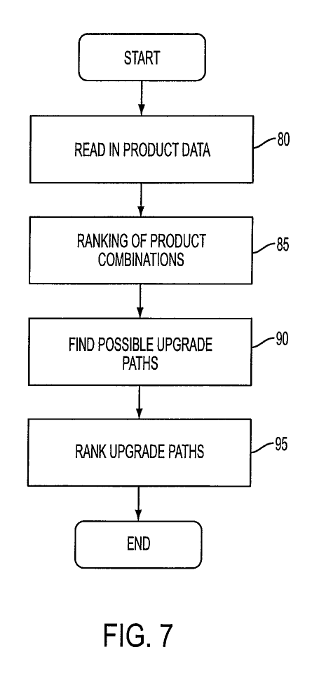

FIG. 8 shows an exemplary output for an upgrade path for various products in accordance with an exemplary embodiment.

FIG. 9 shows an exemplary product list with available versions in accordance with an exemplary embodiment.

FIG. 10 shows an exemplary installed product list in accordance with an exemplary embodiment.

FIG. 11 shows an exemplary capital expenditure matrix in accordance with an exemplary embodiment.

FIG. 12 shows an exemplary operational expenditure chart in accordance with an exemplary embodiment.

FIG. 13 shows an exemplary compatibility matrix for products in accordance with an exemplary embodiment.

FIG. 14 shows an exemplary chart of potential product combinations in accordance with an exemplary embodiment.

FIG. 15 shows an exemplary chart detailing the operational expenditures for each product combination in accordance with an exemplary embodiment.

FIG. 16 shows an exemplary chart detailing costs to change from one combination of products to another in accordance with an exemplary embodiment.

FIG. 17 shows an exemplary chart detailing total costs for different possible solutions in accordance with an exemplary embodiment.

### DETAILED DESCRIPTION

A system and method for predicting the timing and costs of future service, maintenance and replacement events of products or a system in an optimized manner. The system and method are able to predict systematic and different evolution paths for a complete solution, including financial evaluation. Costs can be split into two categories: ongoing costs and software/hardware upgrade/replacement costs. Within these two general categories there are several costs levels exiting for each product. Dependencies between the products may also be categorized into, for example, “no dependencies”, “incompatible”, “dependency secured” or “dependency must be proven.” This is accomplished using a database that stores information related to products of a solution in order to mirror the current state of the network, and forecast different paths of network evolution. The information stored in the database includes, for example, operational costs, upgrade costs, equipment costs, end of life dates, succession products/versions, and probabilities. An operator of the system can specify customized parameters, such that the system outputs recommendations (i.e. predicts) for a timed and cost-optimized upgrade.

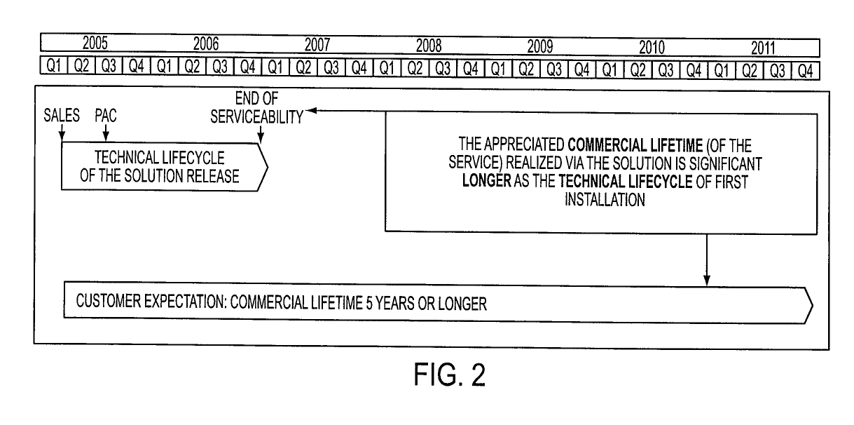

FIG. 2 shows an exemplary diagram of the extended technical solution lifecycle of a network. In order to fulfill end-user requirements, providers/carriers have to operate complex telecommunication and IT based solutions. These solutions are typically combinations of many different products which are often times customized. It is known that new products and solutions have relatively short lifecycles, as seen from the estimated time of sale (Q1/2005) to the end of serviceability (Q4/2006). The appreciated commercial lifetime of the service realized via the system and method becomes significantly longer as compared to the technical lifecycle of the first installation. As depicted in the Figure, the customer expectation for the commercial lifetime becomes, for example, 5 years or more (ending in Q4/2011) as a result of implementing the system recommendations. This enables providers/carriers to limit risk with respect to unexpected costs, for example due to upgrades and replacements, and at the same time allow the providers/carriers to operate solutions at the highest level of stability.

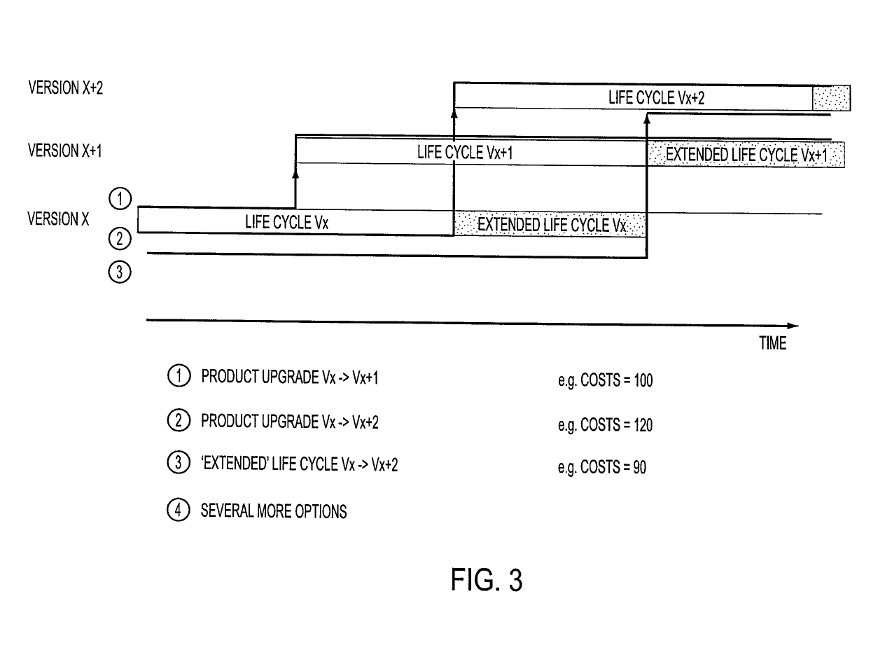

FIG. 3 shows an exemplary diagram illustrating options for a single product upgrade. As depicted, there are various options for deciding when to upgrade a product in the system as well understood by the skilled artisan. Upgrades can be tied to numerous factors, such as time and cost. In this example, three possible options (option 1, 2 or 3) during a given time period (represented in the horizontal direction) are shown for a product with version X, version X+1, and version X+2. Associated costs for upgrading from one version to another version are also illustrated. For example, the cost of upgrading from product Vx to product Vx+1 equals $100, whereas the cost of upgrading from product Vx to Vx+2 equals $120. Selection of option 1 results in the product being upgraded from version X (Vx) to version X+1 (Vx+1) prior to the end of the lifecycle Vx at a cost of $100. In order to maintain the upgrade, product Vx+1 must go into an extended life cycle. Option 2 illustrates selection of a later upgrade to product Vx, at the end of its lifecycle. At this time, Vx is upgraded to Vx+2 at a cost of $120. Finally, selection of option 3 results in a later upgrade, but with slightly lower costs (e.g. $90).

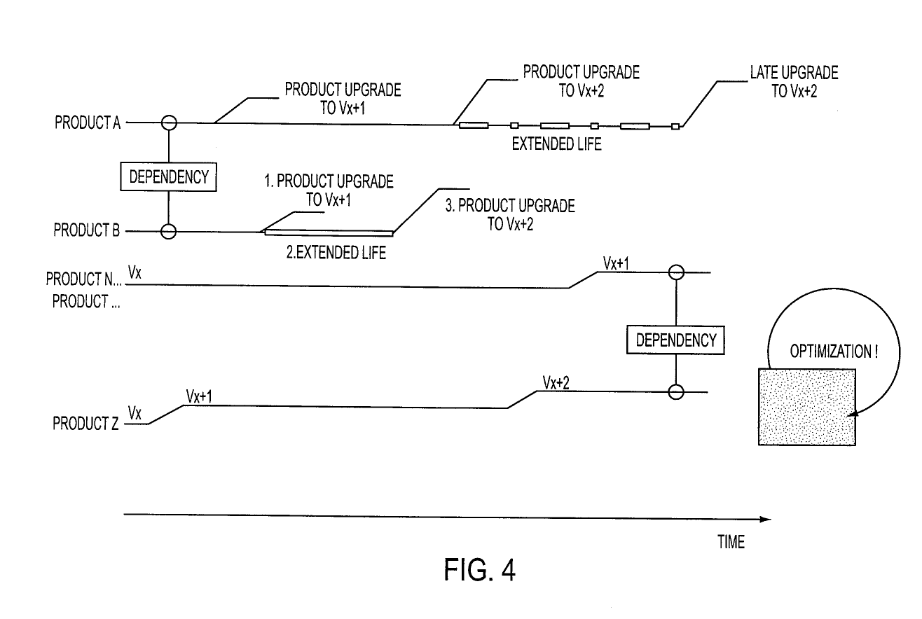

FIG. 4 shows an exemplary diagram illustrating individual lifecycle of products from FIG. 3, with possible upgrade variants in a network solution. Upgrades for each of products A-Z may be determined on an individual basis, as described with reference to FIG. 3. Products, however, are often related (i.e. dependent) on one another in a system, and therefore the upgrade of one product often effects the upgrade of another product. For example, in the illustrated embodiment, products A and B, and products N and Z are dependent upon each other in the system. The determination of when to upgrade products A and N will inevitably effect the determination of when to upgrade products B and Z, respectively, and vice versa.

In version x, the products A and B are related (e.g. a special interaction protocol). As illustrate, the road map of product A shows long upgrade intervals, whereas product B has quicker upgrades. The speed of product B upgrades is therefore higher as compared to product A. However, there is a relationship between the products which is why, in this example, the extended life time Vx of product B is used (to avoid the upgrade to Vx+1). The products N and Z also have a relationship in a upgraded versions, as noted by the dependency at a later time in the roadmap.

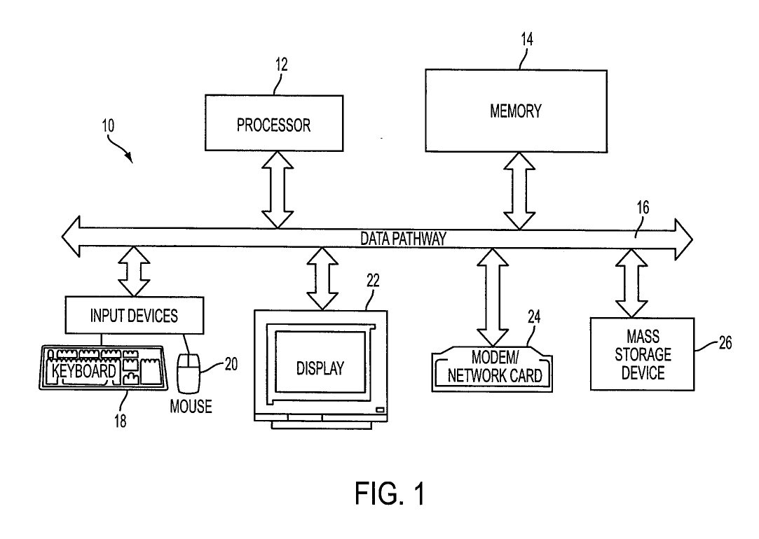

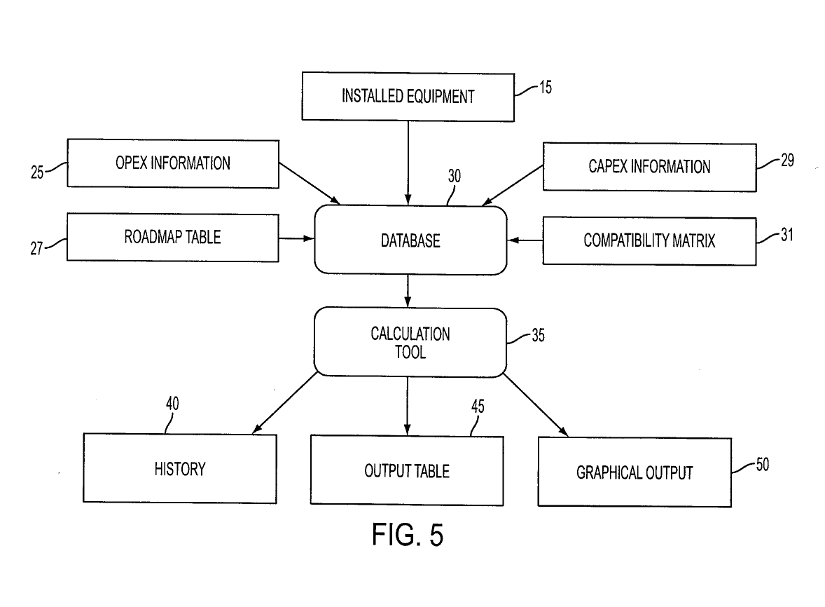

FIG. 5 shows a schematic diagram for calculating lifecycle costs in accordance with an exemplary embodiment. There is a system for automatically predicting the timing and costs of future service, maintenance and replacement events of products or a system in an optimized manner which operates for example on system 10, depicted in FIG. 1. In the depicted system, a database 30 stores various information related to the products in the solution. The information stored in database 30 includes, for example, installed equipment 15, operating expenditure (OPEX) information 25, roadmap table 27, capital expenditure (CAPEX) information 29 and compatibility matrix 31. This information is input into the database 30 for later processing by calculation tool 35. After calculation of selected information stored in the database 30, the system 2 generates an output, which may include a history 40, output table 45 and graphical output 50.

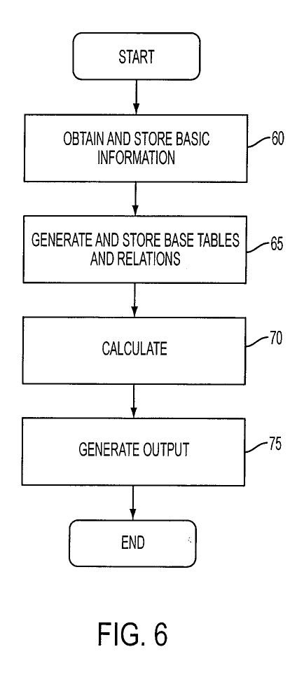

FIG. 6 shows an exemplary flow diagram of the method in accordance with an exemplary embodiment. The method for obtaining, calculating and generating information will now be described. In FIG. 6, information is initially obtained and stored in the database 30 at step 60. This information will include, among other things, product name, product class (e.g. software/hardware), vendor, product costs (investment, depreciation), product operational expenses per month (for: young product phase, normal product phase, after end of life phase, etc.), vendor maintenance, TAC1 costs, operational costs (e.g. power, air-conditioning, floor space, etc.), costs for update (implementation), expected number for updates per year, costs for upgrade (implementation), probability of upgrade costs in future, successor products (Vx+1, Vx+2 . . . replacement), upgrade (licenses) fee, recycling costs, etc. The information collected is then used to generate and store base tables and relations in step 65. The tables include information stored in installed equipment 15, OPEX information 25, roadmap table 27, CAPEX information 29 and compatibility matrix 31, shown in FIG. 5. The database has, for example, a user front end (such as a GUI—graphical user interface) which is the input mask for the user. The user has can fill-in the relevant data (e.g. CAPEX, OPEX). Also, the roadmap can have a dedicated input mask to automatically fill in (i.e. pre-populate) existing information about future releases. The relationship between the products may also be handled in the same way.

In step 70, the information (e.g. installed equipment 15, OPEX information 25, roadmap table 27, CAPEX information 29 and compatibility matrix 31) stored in the database 30 is used to calculate all possible upgrade paths and associated life cycle costs. Once all calculations are completed, an output may be generated in the form of history, tables and graphics, in step 75.

Obtain and Store Basic Information (Step 60)

Information is collected and obtained from various sources, and stored in database 30. In addition to the information noted above, data may include product parameters such as commercial data (e.g. interest rate), product quantities and volume effects, project sites, duration of a project and compatibility data (e.g. relationship between data for upgrades and updates), expected solution lifetime, used products and versions, quantities per product, etc. The obtained information is used to generate various tables, matrices, lists, etc. in step 65, and then processed calculation step 70 to generate an output in step 75.

Generate and Store Base Tables and Relations (Step 65)

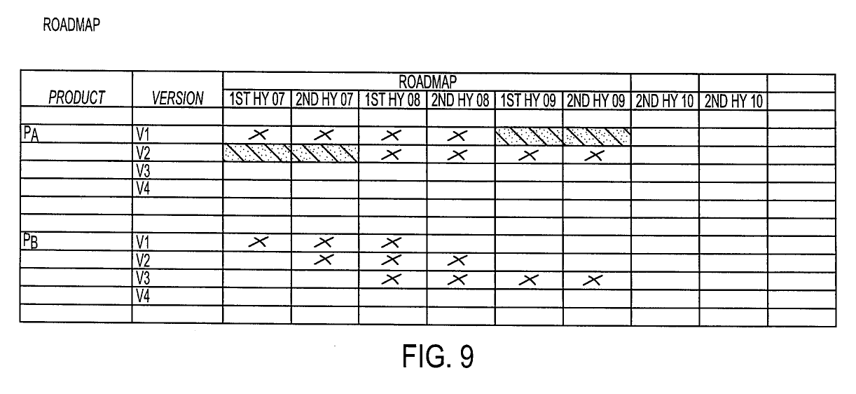

1. Roadmap Table: FIG. 9 shows an exemplary product list with available versions in accordance with an exemplary embodiment. Using the information obtained in step 60, a roadmap for each product in the solution can be generated. This roadmap table 27, preferably appearing in the form of a spreadsheet as depicted, specifies when each product in the solution will become available, including the availability of different versions, the start of sales, end of service, etc. For example, the roadmap table illustrated includes two products—product A and product B, each product having four versions, represented by V1-V4. The availability, start of sales and end of service for each product can be registered, for example, in the table by first and second half of each beginning in the first half of 2007 and ending in last half of 2010.

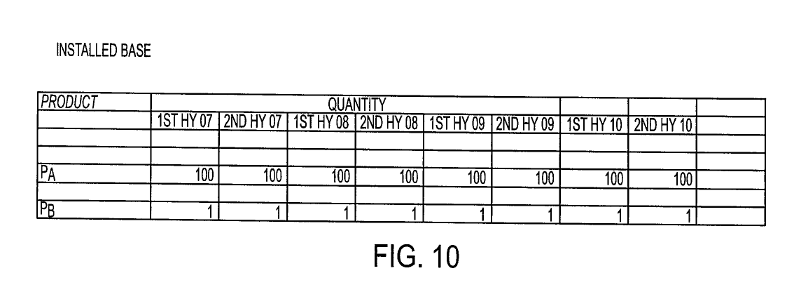

2. Installed Equipment (Base): FIG. 10 shows an exemplary installed product list in accordance with an exemplary embodiment. The installed equipment 15 information is generated using the information obtained in step 60. The information may be obtained by an end-user inputting via input devices 18 and 20, obtained from an existing database of information, or by any other means readily understood by the skilled artisan. This information provides the number of products installed in the network over various time frames. In the example provided, there are 100 units of product A (P_{A}) in each half of years 2007-2010. Product B (P_{B}) on the other hand, has 1 unit for each half of years 2007-2009, and zero units for each half of 2010.

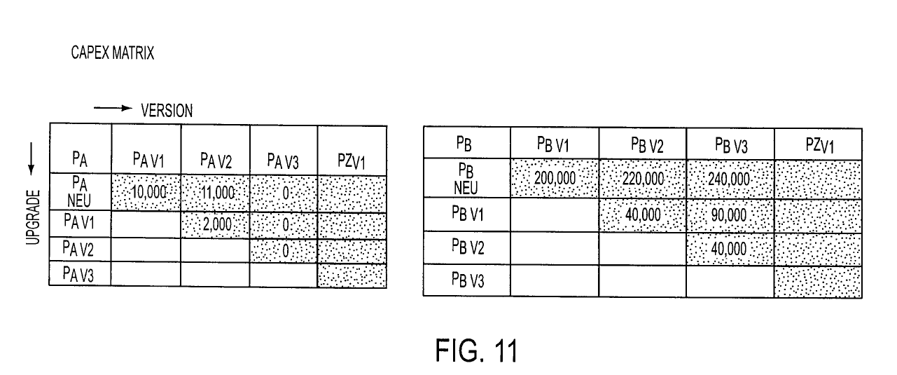

3. CAPEX Information (Matrix): FIG. 11 shows an exemplary capital expenditure matrix in accordance with an exemplary embodiment. The CAPEX information 29 provides, for example, the price per product, price to upgrade a product from version x (Vx) to version Y (Vy), and price to replace a product. In the tables depicted, the version of each product is provided in the first row (P_{Av1}-P_{Zv1} and P_{Bv1}-P_{Zv1}) and the upgraded product (P_{Anew}-P_{Av3} and P_{Bnew}-P_{Bv3}) is provided in the first column. For example, new product P_{Anew} may be upgraded and replaced to version P_{AV1} at a cost of $10,000, to version P_{AV2} at a cost of $11,000, etc. Upgraded product P_{AV1}, on the other hand, would only cost $2 to upgrade and replace to version P_{AV2}. Similarly, new product P_{Bnew} may be upgraded and replaced to version P_{BV1} at a cost of $200,000, to P_{BV2} at a cost of $220,000 and to P_{BV3} at a cost of $240,000. Upgraded product PBV1, on the other hand, would cost $40,000 to upgrade and replace to P_{BV2}, and $90,000 to upgrade and replace to P_{BV3}.

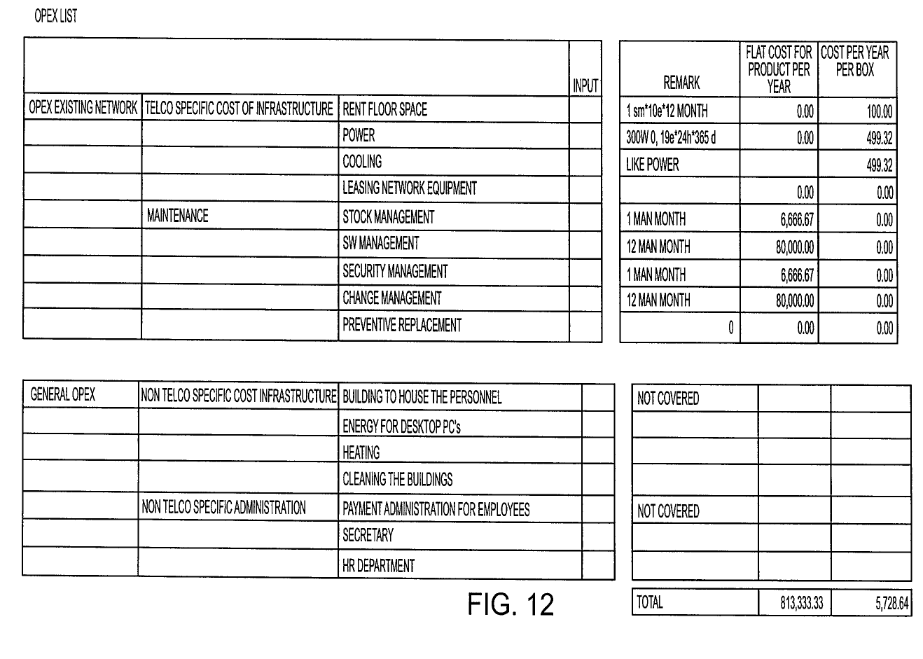

4. OPEX Information (List): FIG. 12 shows an exemplary operational expenditure chart in accordance with an exemplary embodiment. The OPEX information 25 includes, for example, information related to the operating expenditures for each product per year, and for each decade of service. In the chart illustrated in FIG. 12, the OPEX information specifies the operational costs for the existing network, the infrastructure and maintenance, along with general operational costs for infrastructure and administration. The OPEX information and corresponding chart are exemplary and can be modified to include any information required by the end-user, as readily understood by the skilled artisan.

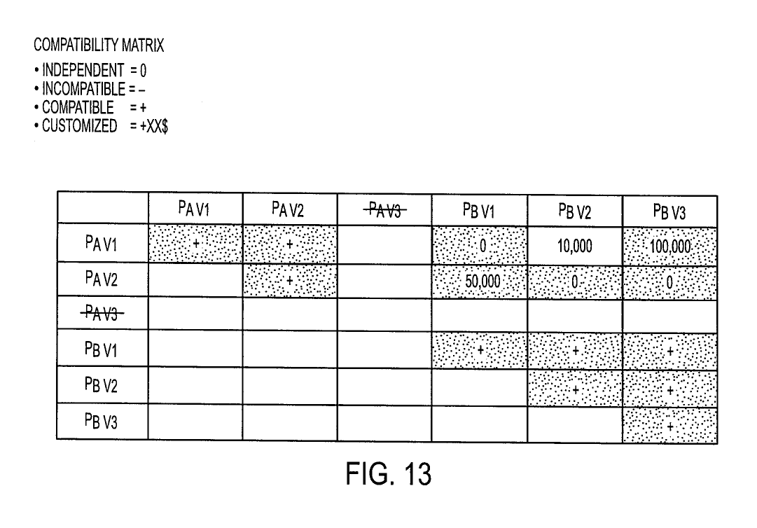

5. Compatibility Matrix: FIG. 13 shows an exemplary compatibility matrix for products in accordance with an exemplary embodiment. The compatibility matrix defines the extent to which products in a solution are compatible with one another, and whether there are any related products (e.g. whether products are dependent on one another). The dependency of products are preferably categorized into 4 areas: (1) Independent: for example, customer premises equipment), (2) Incompatible: for example, the product does not support the required protocol or feature), (3) Compatible: for example, product is completely secure, and (4) Customized: for example, product will comply with solution if modified. The matrix uses symbols to identify which of the categories a given product falls under:
Independent=0
Incompatible=
Compatible=+
Customized=+xx$

For example, in the matrix illustrated in FIG. 13, product P_{AV1} is compatible with P_{AV2} as identified by the “+”, independent from P_{BV1} as identified by the “0” and compatible with P_{BV2} if customized, as identified by “10.000.”

Calculate Upgrade Paths and Lifecycle Costs (Step 70)

1. Read Product Data (Step 80): All relevant information stored in database 30 is read by the calculation tool 35. The information, including the relationships between various products, is processed in the calculation tool 35 under control, for example, of processor 12 (FIG. 1).

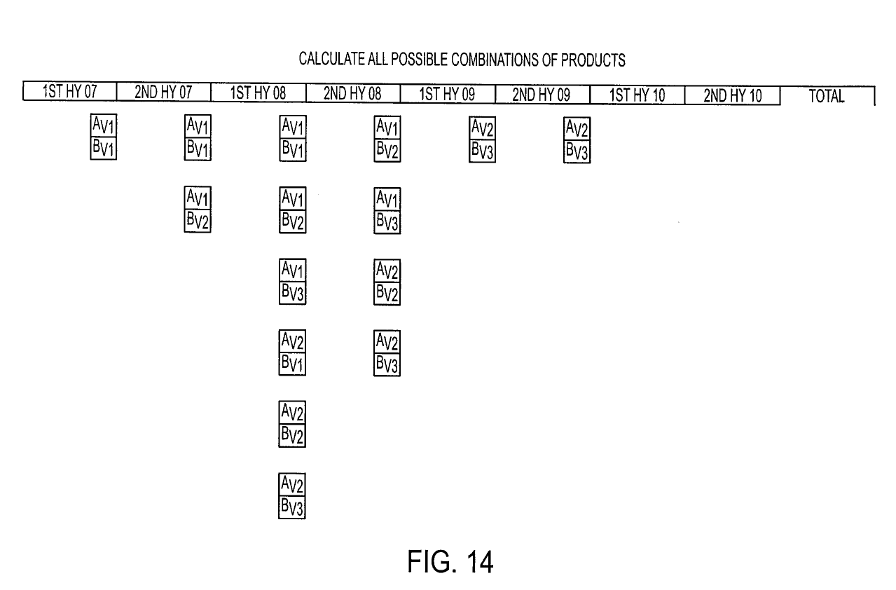

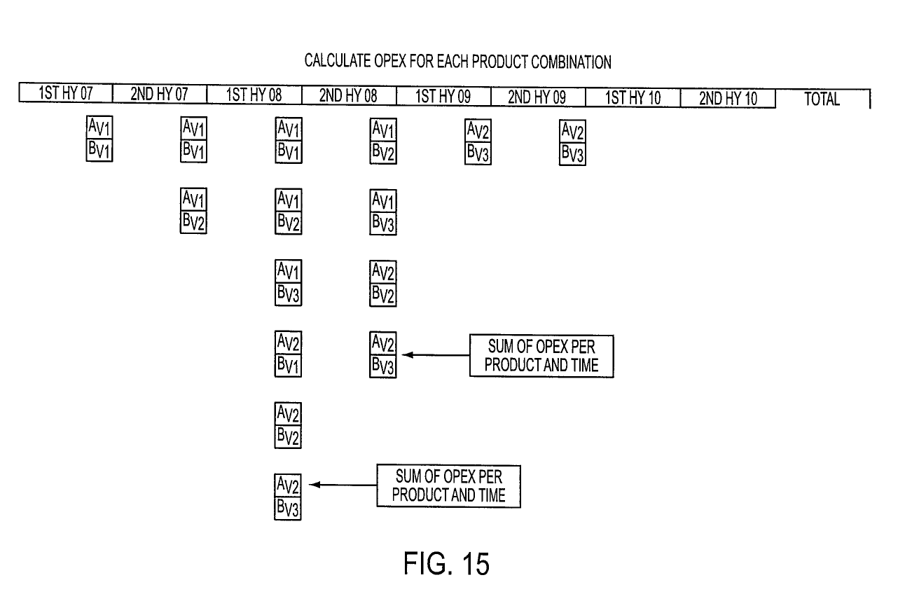

2. Rank Product Combinations (Step 85): Rank all possible product combinations in the particular timeframe according to costs. Calculate all possible combinations of products as illustrated in FIG. 14, and calculate OPEX for each product combination as illustrated in FIG. 15.

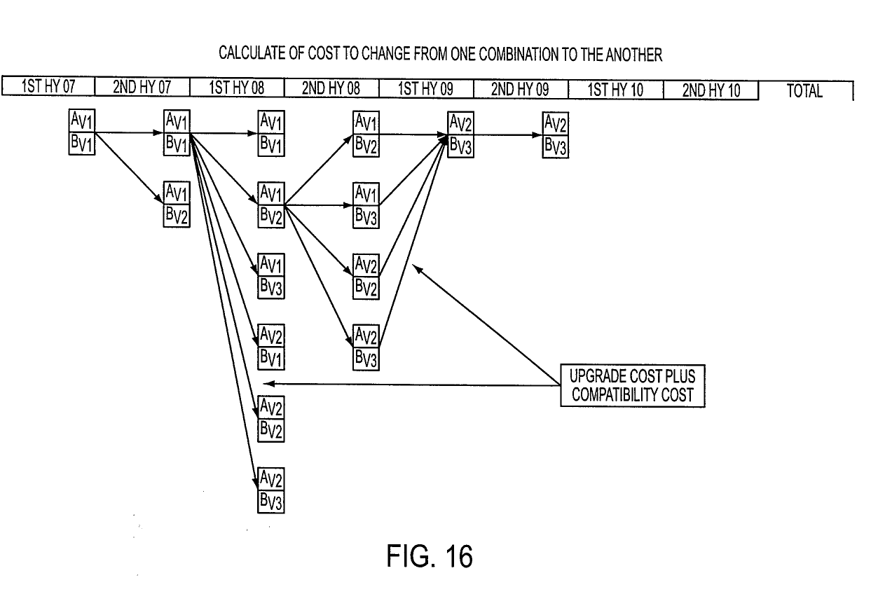

3. Find Possible Upgrade Paths (Step 90): The most cost efficient product combinations of the timeframes are “connected” over the lifetime to form a path. This is represented by the lines (illustrated in the drawings with a line and arrow) between the timeframes and products in the upgrade path. Cost is calculated, based for example on upgrade and compatibility cost, to change from one combination to another combination as illustrated in FIG. 16.

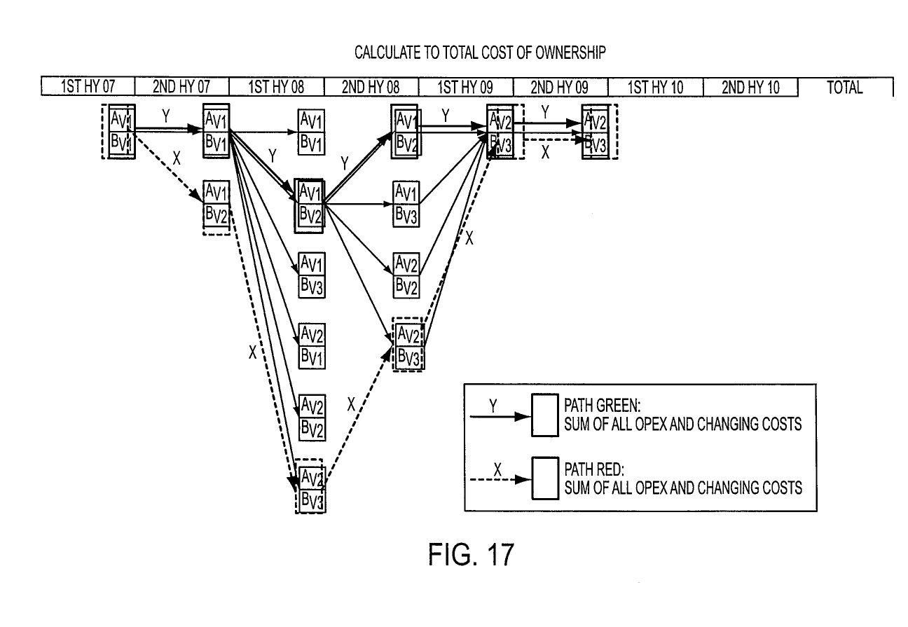

4. Rank Upgrade Paths (Step 95): The calculation tool 35 ranks all upgrade paths according to cost. A path represents the various options for upgrade and compatibility, as determined in the previous steps. The total cost of a solution is calculated based on a selected path, as illustrated in FIG. 17. The calculated paths represent the sum of all OPEX and variable costs. Bolded paths (represented by lines x and y) run to completion, whereas the non-bolded paths end prematurely. In the example provided, the initial solution comprises products A_{V1} and B_{V1}. At the end of the first half of 2007, two different paths may be taken for the solution—following path x or path y. For example, following path x, product A_{V1} remains the same and product B_{V1} is upgraded and replaced with product B_{V2} at a related cost. Following path y, on the other hand, the product versions remain the same, as do costs. Continuing to follow paths x and y into the first half of 2008, path x shows an upgrade of products A_{V1} and B_{V2} to A_{V2} and B_{V3}, respectively, whereas path y shows only an upgrade of product B_{V1} to B_{V2}. The selection of paths continues through the end of the solution lifecycle, in this case into the second half of 2009.

Generate Output (Step 75)

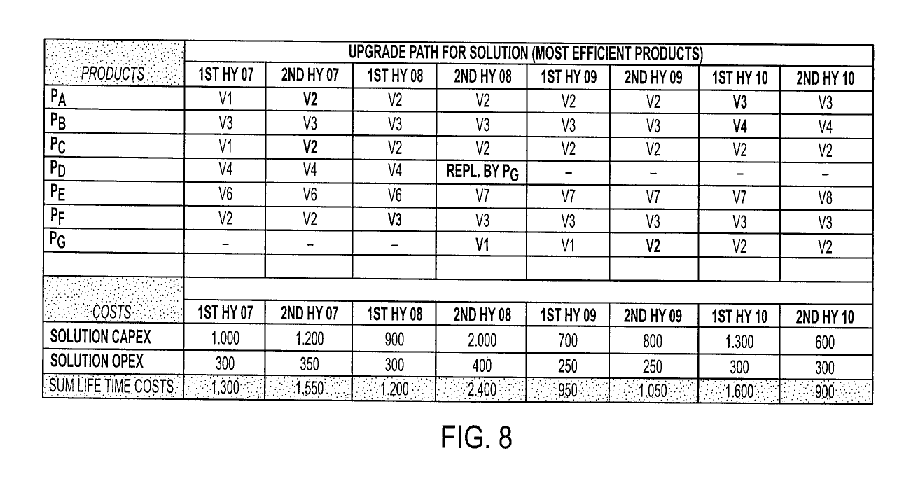

At the end of each path a total cost is calculated, as described above. The total cost is generated by the calculation tool under the control of processor 12, and is output to an end-user in various forms, including for example a product view (e.g. products with lifecycle and advance lifecycle), map view (e.g. correlation of one product to all other products), graphical logo (e.g. visualize correlation between products), result view (e.g. graphical view of used products and versions) and cost view (e.g. monthly costs per product). The output may be displayed, for example, on display 22 (FIG. 1) or stored in memory 14 for use at a later time. FIG. 8 shows an exemplary output for an upgrade path for various products in accordance with the invention. In this exemplary output table, products P_{A}-P_{G} are detailed along with versions for a given upgrade path, and associated costs. In this way, an end-user can easily identify the lifetime costs of a product and solution.

With this system and method, a provider can guarantee long-term serviceability by implementing the necessary measures without any additional cost to the end-user. Maintenance, repair and replacement services for a customized solution are therefore provided, and the risk is assumed by the provider by bundling the best support and all necessary investments into one fix fee contract.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for predicting lifecycle costs of products in a solution, comprising:
a database storing information related to the products in the system;
a calculation tool to determine an accumulated cost for the lifecycle of the solution.

2. The system of claim 1, wherein the calculation tool:
obtains information stored in the database;
ranks combinations for each of the products based on the obtained information;
determines upgrade paths for each of the products based on the obtained information and ranked combinations; and
ranks the upgrade paths based on the determined upgrade paths and overall cost associated with each upgrade path.

3. The system of claim 2, wherein the database comprises:
an installed equipment section storing information identifying the amount of each of the products installed in the system;
an OPEX information section storing operational costs for each of the products, including at least one of infrastructure costs, maintenance costs and administrative costs;
a roadmap table section storing at least one of availability and version information for each of the products;
a CAPEX information section storing capital expenditures for each of the products, including at least one of a price for each of the products, a price to upgrade each of the products and a price to replace each of the products; and
a compatibility matrix section storing information regarding the compatibility of each of the products, the information identifying each of the products as one of independent, incompatible, compatible and customized.

4. The system of claim 3, wherein the information obtained by the calculation tool includes information stored in the installed equipment section, OPEX information section, roadmap table section, CAPEX information section and compatibility matrix section.

5. The system of claim 4, further comprising:
an output device to display the predicted lifecycle costs of the products in the solution based on calculations made by the calculation tool.

6. The system of claim 5, wherein the output device displays at least one of a history, output table and graphical output.

7. The system of claim 1, wherein
the database collects and stores information from a plurality of sources,
the collected and stored information is used to generate tables and relational data about each of the products,
the calculation tool determines the accumulated cost by calculating at least one of ranking combinations for each of the products based on the tables and relational data, determining upgrade paths for each of the products based on the ranked combinations, and ranking the upgrade paths based on the determined upgrade paths and overall cost associated with each upgrade.

8. The system of claim 7, further comprising an output device to display the predicted lifecycle costs of the products in the solution based on calculations made by the calculation tool.

9. A method for predicting lifecycle costs of products in a solution, comprising:
storing information related to the products in the system in a database;
determining an accumulated cost for the lifecycle of the solution using a calculation tool.

10. The method of claim 9, wherein the calculation tool:
obtains information stored in the database;
ranks combinations for each of the products based on the obtained information;
determines upgrade paths for each of the products based on the obtained information and ranked combinations; and
ranks the upgrade paths based on the determined upgrade paths and overall cost associated with each upgrade path.

11. The method of claim 10, wherein the database stores:
installed equipment information identifying the amount of each of the products installed in the system;
operational expenditure costs for each of the products, including at least one of infrastructure costs, maintenance costs and administrative costs;
a roadmap including at least one of availability and version information for each of the products;
capital expenditure costs for each of the products, including at least one of a price for each of the products, a price to upgrade each of the products and a price to replace each of the products; and
a compatibility matrix including information regarding the compatibility of each of the products, the information identifying each of the products as one of independent, incompatible, compatible and customized.

12. The method of claim 11, wherein the information obtained by the calculation tool includes information from the installed equipment information, operational expenditure costs, roadmap, capital expenditure costs and compatibility matrix.

13. The method of claim 12, further comprising:
displaying the predicted lifecycle costs of the products in the solution based on calculations made by the calculation tool.

14. The method of claim 13, wherein the step of displaying includes displaying at least one of a history, output table and graphical output.

15. The method of claim 9, wherein
the database collects and stores information from a plurality of sources,
the collected and stored information is used to generate tables and relational data about each of the products,
the calculation tool determines the accumulated cost by calculating at least one of ranking combinations for each of the products based on the tables and relational data, determining upgrade paths for each of the products based on the ranked combinations, and ranking the upgrade paths based on the determined upgrade paths and overall cost associated with each upgrade.

16. The method of claim 15, further comprising displaying the predicted lifecycle costs of the products in the solution based on calculations made by the calculation tool.

17. A computer-readable medium storing a computer program for instructing a computer to predict lifecycle costs of products in a solution, comprising:
storing information related to the products in the system in a database;
determining an accumulated cost for the lifecycle of the solution using a calculation tool.

18. The computer-readable medium of claim 17, wherein the calculation tool:
obtains information stored in the database;
ranks combinations for each of the products based on the obtained information;
determines upgrade paths for each of the products based on the obtained information and ranked combinations; and
ranks the upgrade paths based on the determined upgrade paths and overall cost associated with each upgrade path.

19. The computer-readable medium of claim 18, wherein the database stores:
installed equipment information identifying the amount of each of the products installed in the system;
operational expenditure costs for each of the products, including at least one of infrastructure costs, maintenance costs and administrative costs;
a roadmap including at least one of availability and version information for each of the products;
capital expenditure costs for each of the products, including at least one of a price for each of the products, a price to upgrade each of the products and a price to replace each of the products; and
a compatibility matrix including information regarding the compatibility of each of the products, the information identifying each of the products as one of independent, incompatible, compatible and customized.

20. The computer-readable medium of claim 19, wherein the information obtained by the calculation tool includes information from the installed equipment information, operational expenditure costs, roadmap, capital expenditure costs and compatibility matrix.

21. The computer-readable medium of claim 20, further comprising:
displaying the predicted lifecycle costs of the products in the solution based on calculations made by the calculation tool.

22. The method of claim 12, wherein the method provides measures in a single fixed fee service contract to secure long-term serviceability.
